(19) United States
(12) Patent Application Publication
(10) Pub. No.: US 2005/0242725 A1
(43) Pub. Date: Nov. 3, 2005

(54) Glass composition and paste composition suitable for a plasma display panel, and plasma display panel

(76) Inventors: Shinya Hasegawa, Ibaraki-shi (JP); Akinobu Miyazaki, Neyagawa-shi (JP); Kazuhiro Yokota, Kobe-shi (JP); Yoshiaki Kai, Neyagawa-shi (JP)

Correspondence Address: SNELL & WILMER L.L.P., 600 ANTON BOULEVARD, SUITE 1400, COSTA MESA, CA, 92626, US

(21) Appl. No.: 11/109,992

(22) Filed: Apr. 20, 2005

(30) Foreign Application Priority Data
Apr. 26, 2004 (JP) 2004-130016

(51) Int. Cl. H01J 17/49; C03C 3/253; C03C 3/14

(52) U.S. Cl. 313/582; 501/42; 501/49

(57) ABSTRACT

A glass composition that is lead-free, and that, when used in a PDP, suppresses coloration of a dielectric layer, a transparent conductive film and a glass substrate, and suppresses reduction in transmittance of the dielectric layer. The glass composition is includes GeO₂ 0.1-20 wt %, B₂O₃ 3-35 wt %, ZnO 4-45 wt %, Bi₂O₃ 10-80 wt %, is free of PbO, and SiO₂ content is not more than 0.5 wt %. It is preferable to further include in the glass composition Al₂O₃ up to 8 wt % and at least one selected from the group consisting of MgO, CaO, SrO, and BaO, up to 20 wt %.

### BACKGROUND OF THE INVENTION

(1) Field of the Invention

The present invention relates to a glass composition, and in particular to a glass composition used for forming the dielectric layer of a plasma display panel.

(2) Description of the Related Art

Plasma display panels (hereinafter also referred to as PDPs) are receiving attention as flat-screen displays.

A PDP is structured from a front plate and a back plate sealed together, the front plate being composed of a front glass substrate on which display electrodes, a dielectric layer and a dielectric protective layer are formed, and the back plate being composed of a back glass substrate on which address electrodes, a dielectric layer, barrier ribs and phosphor layers are formed.

In this PDP, desirable properties in the dielectric layer are sufficient electrical resistance, a high degree of transparency, and a firing temperature that is as low as possible (specifically, being able to be fired at 600° C. or lower). As such, the dielectric layer is typically formed from low-melting point glass.

The low-melting point glass is commonly a lead glass whose principal component is PbO, SiO₂—B₂O₃—PbO being exemplary of such a glass (see Japanese Patent Application Publication No. H3-170346, for example).

However, with lead being considered to be poisonous to humans and harmful to the environment, concerns are held about the effect that lead may have on the environment in both manufacturing and disposing of PDPs. As such, demands are being made for the use of lead-free glass compositions in the dielectric layer.

In view of this situation, lead-free dielectric glass has been proposed, examples of such compositions being bismuth glass that incorporates Bi₂O₃ (see Japanese Patent Application Publication No. 2002-53342), and B₂O₃—ZnO glass that incorporates neither PbO nor Bi₂O₃ (see Japanese Patent Application Publication No. H9-278482).

However, when B₂O₃—ZnO glass is used for the dielectric layer, there is a risk of coloration occurring in the dielectric layer, the transparent conductive film, or the glass substrate, which adversely affects the display characteristics of the PDP. Such coloration is attributable to alkali metal oxides which are incorporated in conventional B₂O₃—ZnO glass to lower the softening point. The alkali metal oxides react with metal of the bus electrodes at the contact interface therewith, causing coloration and lowering the electrical resistance of the dielectric layer.

Furthermore, use of bismuth glass that includes Bi₂O₃ for the dielectric layer may be detrimental to display characteristics because it lowers the transmittance of the dielectric layer, thereby lowering luminance of the PDP. The reason for this is that bismuth glass typically includes SiO₂, which leads to the following problem. The PDP manufacturing process involves numerous heat treatments including a firing process to form the dielectric layer. During these repeated heat treatments deposition of Bi—Si—O microcrystals of bismuth silicon oxide occurs, and the presence of these microcrystals causes scattering of light transmitted through the dielectric layer.

### SUMMARY OF THE INVENTION

In order to resolve the stated problems, the present invention has an object of providing a glass composition that is lead-free, and that, when used for a dielectric layer of a PDP or the like, suppresses coloration of the dielectric layer, a transparent conductive film, and a glass substrate in the PDP, as well as suppressing reduction in transmittance of the dielectric layer, and therefore realizes a PDP having superior display characteristics.

In order to achieve the stated object, the glass composition of the present invention includes GeO₂ 0.1-20 wt %, B₂O₃ 3-35 wt %, ZnO 4-45 wt %, and Bi₂O₃ 10-80 wt %.

Alternatively, the glass composition includes GeO₂ 0.1-20 wt %, B₂O₃ 3-20 wt %, ZnO 4-30 wt %, and Bi₂O₃ 40-80 wt %.

Alternatively; the glass composition includes GeO₂ 0.1-20 wt %, B₂O₃ 12-35 wt %, ZnO 15-45 wt %, and Bi₂O₃ 10-40 wt %.

According to the present invention, Bi₂O₃ content is 10-80 wt %, 40-80 wt %, or 10-40 wt %, and since Bi₂O₃ has an effect of lowering the softening point, the softening point can be lowered without the inclusion PbO.

Furthermore, as described earlier, bismuth glass typically includes SiO₂ in order to obtain stable amorphous glass at the time of manufacturing the glass. However, the glass composition of the present invention includes GeO₂ which has a function of forming the glass network and maintaining stability of the amorphous state. Therefore, stable amorphous glass can be obtained at the time of manufacturing even if the SiO₂ content is not more than 0.5 wt % or if no SiO₂ is included.

Therefore, according to the present invention, glass composition that has a low softening point can be obtained without incorporating lead, and when the glass composition is used for a dielectric layer, an effect can be obtained suppressing coloration of the dielectric layer, the transparent conductive film, and the glass substrate in the PDP, as well as suppressing reduction in transmittance of the dielectric layer.

The glass composition may further include Al₂O₃, however the Al₂O₃ content should be no more than 8 wt %.

Furthermore, the glass composition may further include at least member one selected from the group consisting of MgO, CaO, SrO, and BaO, up to 20 wt %.

The paste composition of the present invention includes the described glass composition, binder resin, and solvent.

Furthermore, in the present invention, in a PDP including an electrode provided on a surface that faces into a discharge space and a dielectric layer provided so as to cover the electrode, the dielectric layer is formed from the aforementioned glass composition.

Furthermore, in the present invention, in a PDP including an electrode provided on a surface that faces into a discharge space, a first dielectric layer provided so as to cover the electrode, and a second dielectric layer provided so as to cover the first dielectric layer, of the first dielectric layer and the second dielectric layer, at least the first dielectric layer is formed from the stated glass composition. Here, the second dielectric layer may be composed of a SiO₂—B₂O₃—ZnO glass composition.

It is preferable that the glass composition that composes the first dielectric layer has a higher softening point that the glass composition that composes the second dielectric layer.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 is a cross sectional drawing of an embodiment of a plasma display panel;

FIG. 2 is a cross sectional drawing of an embodiment of a plasma display panel; and

FIG. 3 is a partial cross sectional perspective view of an embodiment of a plasma display panel.

### DESCRIPTION OF THE PREFERRED EMBODIMENTS

Glass Composition

The glass composition of the present invention is a bismuth glass composition that is essentially free of PbO, and includes GeO₂ 0.1-20 wt %, B₂O₃ 3-35 wt %, ZnO 4-45 wt %, and Bi₂O₃ 10-80 wt %.

Note that “essentially free of PbO” means that lead may be present in a minute amount that does not effect the properties of the glass composition. This is because industrially it is difficult to eliminate Pb entirely.

Within the ranges given above, the Bi₂O₃, GeO₂, B₂O₃, and ZnO content is preferably set to those ranges given in the following first embodiment or the following second embodiment.

First Embodiment

The glass composition of the first embodiment is free of PbO, and includes GeO₂ 0.1-20 wt %, B₂O₃ 3-20 wt %, ZnO 4-30 wt %, Bi₂O₃ 40-80 wt %.

The effects of each component of the glass composition are as follows.

GeO₂is a glass network-forming component, and has an effect of improving stability of the amorphous state. The GeO₂ content must be at least 0.1 wt % in order to obtain this effect. However, deposition of GeO₂ in the glass begins to occur when the GeO₂ content exceeds 20 wt %, and therefore it is preferable that the GeO₂ content is not more than 20 wt %.

Similarly, B₂O₃ also has a glass network-forming effect. In order to obtain amorphous glass, it is preferable that the B₂O₃ is at least 3 wt %. However, the glass begins to lose transparency when the B₂O₃ content exceeds 20 wt %, and therefore it is preferable that the B₂O₃ content is not more than 20 wt %.

In bismuth glass, ZnO has an controlling effect on the softening point of the glass, while improving the chemical durability. It is preferable to include at least 4 wt % ZnO in order to achieve this effect. However, the glass loses transparency when the ZnO content exceeds 30 wt %, and therefore it is preferable that the ZnO content is not more than 30 wt %.

Bi₂O₃ is the major component that realizes a low softening point. Generally, a glass composition used for a dielectric layer in a PDP must have a softening point of 600° C. or lower, and a Bi₂O₃ content of at least 40 wt % is preferable to achieve this. However, the glass becomes unstable and loses transparency when the Bi₂O₃ content exceeds 80 wt %, and therefore it is preferable that the Bi₂O₃ content is not more than 80 wt %.

Second Embodiment

The glass composition of the second embodiment is free of PbO, and includes GeO₂ 0.1-20 wt %, B₂O₃ 12-35 wt %, ZnO 15-45 wt %, Bi₂O₃ 10-40 wt %.

While the effects of the components of the glass composition are as described in the first embodiment, comparing the present embodiment with the first embodiment, the present embodiment has the following characteristics and benefits.

Whereas the Bi₂O₃ content is at least 40 wt % in the first embodiment, the Bi₂O₃ content is relatively low in the second embodiment, specifically, 40 wt % or lower, meaning that the Bi₂O₃ is less effective in lowering the softening point compared to in the first embodiment. However, because this is compensated for by increasing the B₂O₃ content to at least 12 wt % and the ZnO content to at least 15 wt %, B₂O₃ and ZnO contribute significantly to reducing the softening point. This enables the softening point of the glass composition to be kept to 600° C. or below in the present embodiment also.

It should be noted that if the Bi₂O₃ content is lower than 10 wt %, the softening point of the glass composition cannot be kept to 600° C. or below, and therefore it is preferable that the Bi₂O₃ content is at least 10 wt %.

Furthermore, if the B₂O₃ content exceeds 35 wt %, the thermal expansion coefficient falls below the desired range of 65×10⁻⁷/° C. to 85×10⁻⁷/° C., and therefore it is preferable that the B₂O₃ content is not more than 35 wt %. In addition, amorphous glass becomes difficult to achieve when the ZnO content exceeds 45 wt %, and therefore it is preferable that the ZnO content is not more than 45 wt %.

The component in bismuth glass that greatly affects the dielectric constant is Bi₂O₃, the dielectric constant becoming lower as the Bi₂O₃ content is lowered. Since the Bi₂O₃ content in the present embodiment is lower than in the first embodiment, and the dielectric constant is also lower, specifically 11.5 or less. This means that use of the glass of the present embodiment for the dielectric layer of a PDP enables a significant reduction in power consumption.

Effects of the Glass Composition of the Present Invention

The glass compositions of the first and second embodiments enable a lowered softening point without the inclusion of PbO, due to the effect of the Bi₂O₃ which, included in a range of 10-80 wt %, lowers the softening point of the glass composition.

Conventional B₂O₃—ZnO glass includes alkali metal oxides in order to achieve a low softening point. However, the alkali metals may react with the metal included in the electrodes at the interface with the electrodes, thereby causing coloration and reduced electrical resistance. In contrast, the glass composition of the first and second embodiments provides a low softening point without the inclusion of alkali metal oxides. Therefore, in the glass composition of the present invention, the amount of alkali metal oxides can be kept relatively low, and, consequently, a reaction between the alkali metals and the electrodes is unlikely if the glass composition is used for the dielectric layer.

Generally, since the stability of the amorphism of bismuth glass is lower than lead glass and it is more difficult to obtain amorphism when manufacturing the glass, SiO₂ is incorporated in order to obtain stable amorphous glass. However, when SiO₂ is incorporated there is a strong tendency for crystals deposition to occur in the glass in subsequent heat treatment, and in particular, microcrystals such as bismuth silicon oxide may be deposited due to the presence of Bi₂O₃ and SiO₂. When numbers of crystals of several μm or larger in size are deposited on the glass, sufficient display characteristics will be unable to be obtained because transmitted light will scatter.

In contrast, the glass composition of the present embodiments includes GeO₂ which has network-forming effect instead of SiO₂. Therefore, the structural network is formed even if the content of SiO₂ in the glass composition is 0.5 wt % or lower. In addition, GeO₂ is less prone to deposit microcrystals than SiO₂. This enables stable amorphous glass that exhibits extremely low deposition to be provided even at the time of manufacturing of the glass and heat treatment.

Accordingly, a PDP that has superior display characteristics and that does not include lead in the dielectric layer can be achieved if the glass composition of the present embodiments is used for the dielectric layer. This is described in detail later.

The following describes further preferable compositions of the glass composition.

It is preferable to further include Al₂O₃ in the glass composition of the present embodiments. While Al₂O₃ is not an essential component, it is preferable to include a small amount thereof because it improves the stability of amorphous glass. However, since the glass loses transparency if the content of Al₂O₃ exceeds 8 wt %, it is preferable that the Al₂O₃ content is not more than 8 wt %.

Furthermore, at least one oxide selected from the group consisting of MgO, CaO, SrO, and BaO may be included in the glass composition of the present embodiments.

Oxides such as MgO, CaO, SrO, and BaO have the function of assisting glass network formation, and therefore inclusion of an appropriate amount maintains stability of the amorphous state. However, the glass becomes unstable and prone to crystallization if the total content of these oxides exceeds 20 wt %, and therefore it is preferable that the total content of these is not more than 20 wt %.

Other components may be added in order to reformulate the glass as long as the effects of the invention are not lost.

For example, a small amount of alkali metal oxides may be included as long as the there is no loss in the insulation resistance of the dielectric layer and side effects such as discoloration are not caused.

Note that generally in the processing for forming the dielectric layer on the glass substrate when manufacturing a PDP, the dielectric layer is formed by applying the glass composition onto the glass substrate and softening the paste through a heat process. The thermal expansion coefficient of high-strain point glass widely used as the substrate glass is 80×10⁻⁷/° C. to 90×10⁻⁷/° C., and therefore it is preferable that the thermal expansion coefficient of the glass composition that serves as the dielectric layer is in a range of 65×10⁻⁷/° C. to 85×10⁻⁷/° C. in order to reduce residual stress between the substrate glass and the dielectric layer.

Paste Composition

The paste composition of the present invention includes the glass composition of the first and second embodiments, binder resin, and solvent.

The ratio of these is preferably glass composition 30-90 wt %, binder resin 1-10 wt %, and solvent 10-80 wt %. Furthermore, it is preferable to use the glass composition as particles with an average diameter D50 of 0.1 μm to 3 μm when measured according to laser diffraction.

Examples of preferable binder resin include cellulose resins such as nitrocellulose, ethylcellulose and hydroxyethylcellulose, acrylic resins such as polybutyl acrylate and polymethacrylate, copolymers, polyvinyl alcohols, and polyvinyl butyrals.

Examples of preferable solvents include terpins such as α-, β- and γ-terpineol, ethylene glycol monoalkyl ethers, ethylene glycol dialkyl ethers, diethylene glycol monoalkyl ethers, diethylene glycol dialkyl ethers, ethylene glycol monoalkyl ether acetates, ethylene glycol dialkyl ether acetates, diethylene glycol monoalkyl ethers acetates, diethylene glycol dialkyl ethers acetates, propylene glycol monoalkyl ethers, propylene glycol dialkyl ethers, propylene glycol monoalkyl ether acetates, propylene glycol dialkyl ether acetates, and alcohols such as methanol, ethanol, isopropanol, and 1-butanol.

Note that an arbitrary additive such as inorganic material powder, a plasticizer or a dispersant may be further added to the paste composition of the present embodiment.

Application of the Present Invention as the Dielectric Layer of a PDP

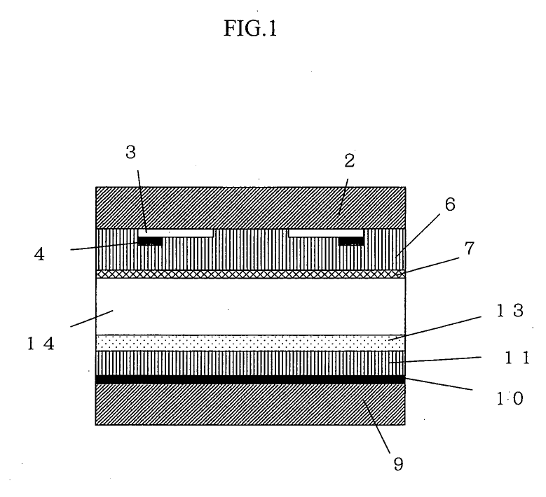

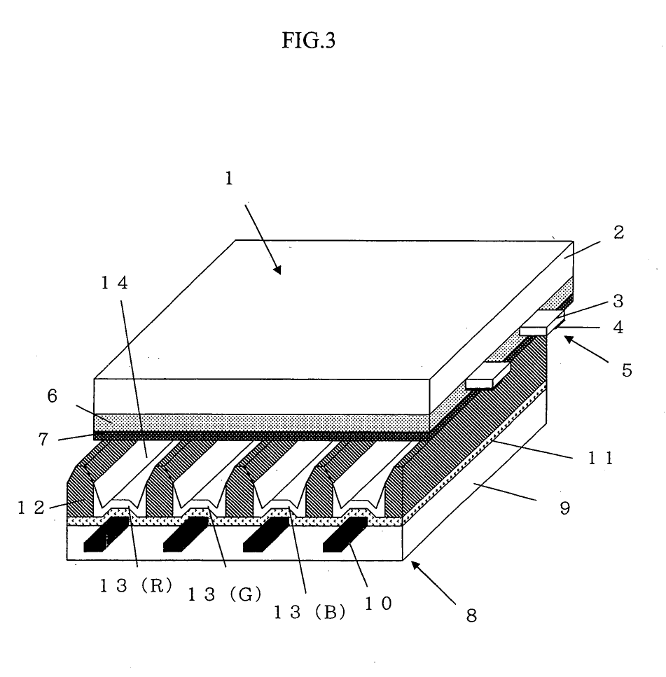

FIG. 3 is a partial cross sectional perspective drawing showing the main structure of the PDP of the present embodiment. FIG. 1 is a cross sectional drawing of the PDP.

This PDP is an AC surface discharge PDP, and essentially has the structure of a conventional PDP, with the exception of the dielectric layer being composed of the described glass composition.

This PDP is composed of a front plate 1 and a back plate 8 which are sealed together. The front plate 1 is composed of a front glass substrate 2, displays electrodes 5 which consist of a transparent conductive film 3 and a bus electrode 4 and are formed on the inner surface of the front glass substrate 2 (the surface that faces a discharge space 14), a dielectric layer 6 that covers the display electrodes 5, and a dielectric protective layer 7 made of magnesium oxide. The described glass composition is used for the dielectric layer 6.

Furthermore, the back panel 8 is composed of a back glass substrate 9, address electrodes 10 formed on one surface of the back glass substrate 9, a dielectric layer 11 that covers the address electrodes 10, barrier ribs 12 provided on the upper surface of the dielectric layer 11, and phosphor layers formed between the barrier ribs 12. The phosphor layers consist of red phosphor layers 13(R), green phosphor layers 13(G), and blue phosphor layers 13(B) arranged alternatively in the stated order.

The front plate 1 and the back plate 8 are arranged facing each other such that the display electrodes 5 and the address electrodes 10 are orthogonal to each other in terms of their respective lengthwise directions, and joined together with a sealing member (not illustrated). The display electrodes 5 are formed by layering the bus electrodes 4, which are made of Ag, Al or Cr/Cu/Cr, respectively on the transparent conductive films 3, which are made of ITO or tin oxide. Here, Ag, Al or Cr/Cu/Cr are used in order to ensure good conductivity.

The display electrodes 5 and the address electrodes 10 are connected to respective external driving circuits (not illustrated). Voltage applied by the driving circuits generates discharge in the discharge spaces 14, and ultraviolet rays with a short wavelength (147 nm) that occur with the discharge excite the phosphor layers 13. This results in emission of visible light.

In this PDP, since the dielectric layer 6 is lead-free and includes only a small amount of alkali metals, the problem of the alkali metal reacting with the metal (for example, Ag, Al, Cu) in the bus electrodes 4 and the Sn in the transparent conductive films 3 and causing coloration of the front plate 1 and reduction of the electrical resistance of the dielectric layer 6 is avoided.

The dielectric layer 6 may be formed by applying the described glass paste, and then firing this arrangement.

More specifically, an example of a method representative of those that may be used to form the dielectric layer 6 is one by which the paste composition is applied, for instance, by screen printing, a bar coater, a roll coater, a dye coater, or a doctor blade, and the resulting arrangement is fired. However, the method used is not limited to this, a further possible method being one by which sheets that include the glass composition are applied and the resulting arrangement is fired.

It is preferable that the thickness of the dielectric material is not more than 50 μm. This is in order to control loss of transmitted light.

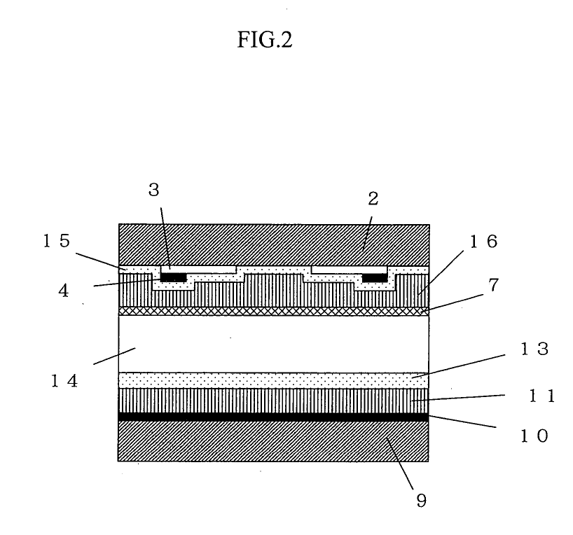

The following describes an example where the glass composition of the present invention is used in a PDP in which the dielectric layer has a bi-layer structure as shown in FIG. 2.

In the PDP shown in FIG. 2, the bi-layer structure consists of a first dielectric layer 15 and a second dielectric layer 16 which are provided in place of the dielectric layer 6. The PDP shown in FIG. 2 is identical to the PDP of FIG. 1 in all other aspects.

As shown in FIG. 2, the first dielectric layer 15 covers the transparent conductive films 3 and the bus electrodes 4, and the second dielectric layer 16 further covers the first dielectric layer 15.

When the dielectric layer has a bi-layer structure as in the present case, the glass composition of the present invention is used for the first dielectric layer 15. This means that reduction in transmittance due to crystal deposition is avoided, and lead is omitted, at least in the first dielectric layer 15.

Furthermore, if glass with a relatively high amount alkali metal content is used for the second dielectric layer 16, coloration of the front plate 1 and reduction of the electrical resistance of the dielectric layer are suppressed because of the low amount of alkali metal in the first dielectric layer 15 which directly contacts the electrodes 3 and 4.

Therefore, it is possible either use the glass composition of the present invention for the second dielectric layer 16 or to use another glass composition for the second dielectric layer 16. However, use of the glass composition of the present invention for both the first dielectric layer 15 and the second dielectric layer 16 enables reduction of the transmittance which occurs due to crystal diffusion to be prevented throughout the whole dielectric layer, and provides an even more highly reliable PDP.

On the other hand, if, for example, a SiO₂—B₂O₃—ZnO glass composition is used for the second dielectric layer 16, this SiO₂—B₂O₃—ZnO glass has a lower dielectric constant than lead glass or bismuth glass (generally at room temperature the dielectric constant is 10-15 for lead glass, 8-13 for bismuth glass, and 5-9 for SiO₂—B₂O₃—ZnO glass). Therefore, the energy consumption of the PDP can be lowered by using SiO₂—B₂O₃—ZnO glass for the second dielectric layer 16.

Note that in the case of SiO₂—B₂O₃—ZnO glass, the following composition is preferable to achieve a low softening point of 600° C. or lower and non-crystallizing stable amorphism: SiO₂ 5-25 wt %; B₂O₃ 25-50 wt %; ZnO 25-60 wt %; Al₂O₃ not more than 6 wt %; and, in addition, at least one of Li₂O, Na₂O, K₂O, and Cs₂O not more than 20 wt %; and of at least one of MnO₂, CuO, and TiO₂ not more than 10 wt %.

The reasons for stipulating the content of the components in the stated ranges are as follows.

SiO₂ is a glass network-forming component, and it is preferable that the glass composition contains SiO₂ at least 5 wt % in order obtain a stabilizing effect. However, it is undesirable for the SiO₂ content to exceed 25 wt % because this tends to cause the softening point to rise and exceed 600° C.

B₂O₃ has an effect of lowering the softening point while also forming the glass network, and it is preferable that the glass composition contains B₂O₃ at least 25 wt %. However, it is undesirable for the total content to exceed 50 wt % because this lowers the thermal expansion coefficient.

It is preferable that the ZnO content is at least 25 wt % in order to serve to stabilize the glass and maintain the low softening point. However, it is undesirable for the ZnO content to exceed 60 wt % because this causes the glass to lose transparency.

While Al₂O₃ is not an essential component, it is preferable to include a small amount because it prevents loss of transparency of the glass. However, it is undesirable for the Al₂O₃ content to exceed 6 wt % because this tends to cause the softening point to rise and exceed 600° C.

At least one of Li₂O, Na₂O, K₂O, and Cs₂O is preferably included because these have an effect of lowering the softening point. However, it is undesirable for the total content to exceed 20 wt % because this causes the thermal expansion coefficient to increase.

MnO₂ and CuO have an effect of suppressing discoloration caused by a reaction between the dielectric layer and the electrodes, and therefore it is preferable to include these if there is a possibility that discoloring will occur. Furthermore, since the dielectric constant can be greatly changed by the addition of a small amount of TiO₂, it is preferable to include TiO₂ if the design of the PDP necessitates adjustment of the dielectric constant. However, it is undesirable for the total content of at least one member selected from the group consisting of MnO₂, CuO and TiO₂ to exceed 10 wt % because this causes the glass to lose transparency.

Note that in addition to the above components, at least one member selected from the group consisting of P₂O₅, V₂O₅ and TeO₂ may be further included in order to adjust the softening point. Furthermore, at least one member selected from the group consisting of MgO, CaO, SrO and BaO may be included in order to stabilize the amorphous state.

The bi-layer structure dielectric layer can be formed by applying glass composition for the second dielectric layer after the first dielectric layer 15 has been formed, and then firing the arrangement. When this method is used, it is preferable that the glass composition used for the first dielectric layer 15 has a softening point that is higher than the softening point of the glass composition used for second dielectric layer.

It is also preferable that the first dielectric layer 15 is at least 1 μm thick in order to insulate between the electrodes 3 and 4 and the second dielectric layer 16 and prevent a surface reaction therebetween.

Furthermore, it is preferable that the combined thickness of the first conductive layer and the second conductive layer is not more than 50 μm in order to control loss of transmitted light.

As has been described, by applying the described glass composition of the present invention to the dielectric layer of a PDP, the problem of reduced display characteristics caused by discoloration and reduction of transmittance of the dielectric layer can be controlled without the presence of lead.

Note that the described surface discharge PDP is representative of PDPs to which the glass composition of the present invention can be applied. However, the glass composition is not limited to being applied to this type of PDP, and may be applied to an opposite discharge PDP.

Furthermore, the PDP is not limited to being an AC PDP. The present invention may be applied to a DC PDP if the PDP includes a dielectric layer.

### IMPLEMENTATION EXAMPLES

The following describes implementation examples of the glass composition, the glass paste, and the PDP of the present invention. Note that the present invention is not limited to these implementation examples.

### Implementation Example 1

### Glass Composition and Glass Paste

TABLE 1

| | | | | | COMPARISON | |
|---|---|---|---|---|---|---|
| | IMPLEMENTATION EXAMPLES | | | | EXAMPLES | |
| No. | 1 | 2 | 3 | 4 | 5 | 6 |
| COMPONENT | | | | | | |
| (wt %) | | | | | | |
| SiO₂ | | | | | 15.7 | 12.0 |
| GeO₂ | 9.7 | 8.1 | 11.7 | 10.8 | | |
| B₂O₃ | 7.3 | 5.7 | 8.0 | 8.7 | 6.6 | 7.0 |
| ZnO | 13.6 | 13.3 | 14.9 | 16.7 | | 6.5 |
| Bi₂O₃ | 68.3 | 69.0 | 64.2 | 63.8 | 76.9 | 74.5 |
| Al₂O₃ | 1.1 | 0.8 | 1.2 | | 0.8 | |
| CaO | | 1.2 | | | | |
| SrO | | 1.9 | | | | |
| SOFTENING POINT (° C.) | 535 | 530 | 552 | 547 | 540 | 531 |
| THERMAL EXPANSION | 80 | 83 | 79 | 79 | 78 | 76 |
| COEFFICIENT | | | | | | |
| ( ×10⁻⁷/° C.) | | | | | | |
| DIELECTRIC CONSTANT | 12.1 | 12.5 | 12.0 | 12.0 | 12.5 | 12.3 |
| STABILITY | GOOD | GOOD | GOOD | GOOD | POOR | POOR |

TABLE 2

| | IMPLEMENTATION EXAMPLES | | | | |
|---|---|---|---|---|---|
| No. | 11 | 12 | 13 | 14 | 15 |
| COMPONENT | | | | | |
| (wt %) | | | | | |
| SiO₂ | | | | | 0.5 |
| GeO₂ | 12.6 | 10.3 | 0.7 | 12.0 | 6.1 |
| B₂O₃ | 19.4 | 20.9 | 28.0 | 25.9 | 17.9 |
| ZnO | 24.8 | 27.7 | 40.8 | 19.3 | 23.0 |
| Bi₂O₃ | 34.5 | 25.5 | 10.3 | 18.1 | 31.9 |
| Al₂O₃ | 0.9 | | 1.2 | 4.7 | 0.9 |
| CaO | 7.8 | 6.6 | | | |
| SrO | | 9.0 | | | |
| BaO | | | 19.0 | 20.0 | 19.7 |
| SOFTENING POINT | 597 | 598 | 580 | 585 | 583 |
| (° C.) | | | | | |
| THERMAL | 76 | 77 | 78 | 76 | 80 |
| EXPANSION | | | | | |
| COEFFICIENT | | | | | |
| ( ×10⁻⁷/° C.) | | | | | |
| DIELECTRIC | 11.5 | 10.8 | 10.1 | 9.8 | 11.4 |
| CONSTANT | | | | | |
| STABILITY | GOOD | GOOD | GOOD | GOOD | GOOD |

Implementation examples and comparison example of a glass composition were produced using the components shown in Table 1, and paste was then produced using these glass compositions.

Nos. 1-4 shown in Table 1 are implementation examples of the first embodiment which include GeO₂ 0.1-20 wt %, B₂O₃ 3-20%, ZnO 4-30 wt %, and Bi₂O₃ 40-80 wt %, but do not include SiO₂. In contrast, Nos. 5 and 6 are comparison examples which include B₂O₃, Bi₂O₃, and SiO₂, but do not include GeO₂.

Nos. 11-15 shown in Table 2 are implementation examples of the second embodiment which include GeO₂0.1-20 wt %, B₂O₃ 12-35%, ZnO 15-45 wt %, and Bi₂O₃ 10-40 wt %, but include either no SiO₂ or an SiO₂ content of not more than 0.5 wt %.

The following details how the example glass compositions were produced.

After measuring and mixing the ingredients for each glass composition, each obtained mixture was put into a platinum crucible and melted in an electric oven at 1100-1350° C. for one hour. Next, the obtained melted glass was rapidly quenched using a roller to produce the glass compositions. Furthermore, the glass compositions were crushed in a ball mill to obtain glass particles of an average grain diameter D50 of 1.5 μm to 2.2 μm.

The softening point, thermal expansion coefficient, and dielectric constant of each obtained glass composition was measured. The softening points were determined from a chart obtained by a macro TG-DTA subjecting the glass particles to a heating rate of 10° C./min. The thermal expansion coefficient was measured by re-melting the glass and forming a 4×4×20-mm rod, and measuring using a thermomechanical analyzer. The dielectric constant was measured by re-melting the glass to form a 50×50×3-mm plate, forming electrodes on a surface of the plate according to deposition, and measuring at a frequency of′ 1 MHz using an LCR meter.

Next, each set of obtained glass particles was mixed with a vehicle consisting of ethylcellulose dissolved in α-terpineol, and made into a paste using a three roll mill. The paste compositions were produced so as to include glass composition 60 wt %, ethylcellulose 5 wt %, and α-terpineol 35 wt %.

The stability of each glass paste was measured by screen printing the glass paste onto a glass substrate, subjecting each resulting arrangement to heat treatment for 30 minutes at the respective softening point, and then observing with an optical microscope. Those that did not exhibit deposition of crystals of 10 μm or larger were evaluated as “good”, and those that did exhibit deposition of crystals of 10 μm or larger were evaluated as “poor”.

The softening points, thermal expansion coefficients, dielectric constants, and glass stability evaluation results are as shown in Table 1 and Table 2.

The glass compositions of the implementation examples and the comparison examples all showed a softening point below 600° C., and a thermal expansion coefficient in a range of 65×10⁻⁷/° C. to 0.85×10⁻⁷/° C.

In terms of dielectric constant, Nos. 1-4 of the implementation examples and the comparison examples were approximately the same, but Nos. 11-15 of the implementation examples, which contain less Bi₂O₃, have lower dielectric constants than Nos. 1-4 of the implementation examples.

In terms of glass stability, all of the implementation examples were “good”, and both the comparison examples were “poor”. These results show that the implementation example glass is stable amorphous glass that does not exhibit crystal deposition according to heat treatment, due to the fact that it does not contain SiO₂, whereas the comparison example glass exhibits crystal deposition due to heat treatment and is unstable because of the absence of SiO₂.

The following Implementation Examples 2 and 3 describe examples of the glass composition of Implementation example 1 being used for the dielectric layer of a PDP.

### Implementation Example 2

First, an ITO transparent dielectric layer-forming paste was screen printed onto a front glass substrate made of high-strain point glass, and Ag paste for forming bus electrodes that assist conductivity was screen printed on top of the ITO transparent dielectric layer-forming paste. This was fired, thereby forming display electrodes.

Next, each of pastes produced using the aforementioned glass compositions No. 3 and No. 14, respectively, was screen printed on top of the display electrodes and baked at 560° C. in the case of No. 3 and 590° C. in the case of No. 14 in order to form a dielectric layer. The dielectric layer was formed to be 30 μm thick. A dielectric protective layer made of magnesium oxide was formed on the surface of this dielectric layer by deposition, thereby completing the front plate.

Next, Ag electrode paste was screen printed in a stripe formation on a back glass substrate that is made of high strain-point glass, and by firing this arrangement address electrodes were formed. Paste that includes the dielectric glass was then screen printed on top of the address electrodes by screen printing, and by firing this arrangement the dielectric layer was formed.

Next, barrier ribs for partitioning the discharge space were formed in a stripe formation by photoetching, and phosphor of the three colors red (R), green (G), and blue (B) was applied alternatively in the stated order in the areas that are to be the discharge space by screen printing. This arrangement was fired to form phosphor layers, and thereby complete the back plate.

A paste made of sealing frit was then applied on the edges of the back plate produced as described, the front plate and back plate were placed together so that the display electrodes were orthogonal to the address electrodes, and the front plate and the back plate were joined together.

Next, the terminal of a glass evacuation tube was connected to a through hole provided in the back plate. This connection was made by injecting a paste that includes sealing frit to the edge of the opening of the though hole, and then firing this arrangement.

Next, while heating the whole arrangement, internal gas was evacuated through the glass tube, discharge gas was introduced through the glass tube into the discharge space at a predetermined pressure, and then the glass tube was heated to be sealed. Finally, when the display electrodes and the address electrodes were connected to external driving circuits, the PDP was complete.

The display characteristics of the PDPs produced in this way were evaluated while the PDPs performed illumination display, the results showing that the PDPs did not exhibit problems such as discoloration and coloration of the panel and lowering of transmittance.

Panel Evaluation:

Coloration of the panel was measured using a calorimeter, and the panel was evaluated for discoloring. Variations in the measured value can be seen when discoloring has occurred due to the dielectric layer reacting with the electrodes and when coloration has occurred in the dielectric layer itself.

Furthermore, luminance of the PDP was measured using a display color analyzer with the PDP is a state of full-screen illumination, and the display characteristics were evaluated.

### Implementation Example 3

In the present implementation example, the dielectric layer that covers the display electrodes is a bi-layer structure consisting of a first dielectric layer and a second dielectric layer. The glass composition of one of the implementation examples is used for both the first and second dielectric layers.

The following describes the method used to manufacture the PDP.

The PDP of implementation example 3 was manufactured using the same method as that of implementation example 2, with exception of the process for forming the dielectric layer on the front plate.

In the process for forming the dielectric layer, a paste composition produced using the glass composition No. 3 was applied on top of the display electrodes, and the arrangement fired at 560° C. to form the first dielectric layer. Next a paste composition produced using the glass composition No. 1 was applied on top of the first dielectric layer, and the arrangement fired at 545° C. to form the second dielectric layer.

The first dielectric layer was formed to be 5 μm thick and the second dielectric layer was formed to be 25 μm thick.

The completed PDP was evaluated in terms of display characteristics as described above, and the luminance was found to be good. This result shows that the PDP did not exhibit problems such as discoloration and coloration of the panel and lowering of transmittance.

### Implementation Example 4

In implementation example 4 also, the dielectric layer covering the display electrodes is a bi-layer structure consisting of a first dielectric layer and a second dielectric layer. However, the glass composition of implementation example 1 was used for the first dielectric layer and an SiO₂—B₂O₃—ZnO glass composition was used for the second dielectric layer.

The following describes the method used to manufacture the PDP.

The PDP of implementation example 4 was manufactured using the same method as that of implementation example 2, with exception of the process for forming the dielectric layer on the front plate.

In the process for forming the dielectric layer, the first dielectric layer was formed in that same way as in implementation example 3.

Next, a paste composition produced using a glass composition consisting of SiO₂, B₂O₃, ZnO, Al₂O₃, K₂O (softening point 545° C., dielectric constant 6.8) was applied, and the arrangement fired at 550° C. to form the second dielectric layer.

The first dielectric layer was 5 μm thick and the second dielectric layer was 15 μm thick.

The luminance of the PDP manufactured in this way was measured while having the PDP perform full illumination display, and as a result of evaluating display characteristics, luminance was found to be good. This result shows that the PDP did not exhibit problems such as discoloration and coloration of the panel and lowering of transmittance.

The luminance and the power consumption of PDPs of implementation examples 2 to 4 and a PDP of one of the comparison examples were measured.

The comparison example PDP was produced based on the method described in implementation example 2, using glass composition No. 5 and firing the dielectric layer at 545° C.

The power consumption of each PDP was measured by having the PDP perform full illumination display, measuring the voltage applied to the electrodes and the discharge current flowing at that time, and calculating the product thereof. The results are as shown in Table 3.

TABLE 3

| | IMPLEMENTATION | | IMPLEMENTATION | IMPLEMENTATION | COMPARISON |
|---|---|---|---|---|---|
| | EXAMPLE 2 | | EXAMPLE 3 | EXAMPLE 4 | EXAMPLE |
| GLASS COMPOSITION | No. 3 | No. 14 | No. 3 + | No. 3 + | No. 5 |
| USED FOR | | | No. 1 | SiO₂ − B₂O₃ − | |
| DIELECTRIC LAYER | | | | ZnO | |
| LUMINANCE | 122 | 123 | 120 | 125 | 100 |
| (RELATIVE VALUE %) | | | | | |
| POWER | 97 | 89 | 98 | 82 | 100 |
| CONSUMPTION | | | | | |
| (RELATIVE VALUE %) | | | | | |

Note that the values of luminance and power consumption shown in Table 3 are relative values where the values for the comparison examples are 100.

The results in Table 3 show that each of the PDPs of implementation examples 2 to 4 has higher luminance than the comparison example.

Furthermore, the results show that the PDP of implementation example 2 that uses glass composition No. 14 and the PDP of implementation example 4 have relatively low power consumption compared to the comparison example. The reduction in power consumption is thought to be attributable to the relatively low dielectric constant of the dielectric layer (In implementation example 4, the dielectric constant of the whole dielectric layer is relatively low because the dielectric constant of the second dielectric layer of implementation example 3 is relatively low).

Applications other than PDPs

As has been described, the glass composition of the present invention can be used for the dielectric layer of a PDP as a lead-free, low-melting point glass. However, the glass composition of the present invention may be used for other purposes such as adhering, sealing and coating ceramics, glass, metals, and the like.

Furthermore, the glass composition of the present invention can be used in paste composition having various functions. For example the glass composition may be used in place of low-melting point glass materials conventionally used in various ways such as components for electronic devices. Specifically, the glass composition may be used in various types of LCR components, semiconductor packages and other electronic components, as well as display devices such as CRTs, liquid crystal display panels, fluorescent display tubes, and FEDs. In addition, the glass composition may be used in lamp products for lighting purposes, porcelain products, ceramic products, and the like.

Although the present invention has been fully described by way of examples with reference to the accompanying drawings, it is to be noted that various changes and modification will be apparent to those skilled in the art. Therefore, unless otherwise such changes and modifications depart from the scope of the present invention, they should be construed as being included therein.

1. A glass composition comprising:
GeO₂ 0.1-20 wt %;
B₂O₃ 3-35 wt %;
ZnO 4-45 wt %; and
Bi₂O₃ 10-80 wt %.

2. The glass composition of claim 1, further comprising:
at least one member selected from the group consisting of MgO, CaO, SrO, and BaO, not more than 20 wt % in total.

3. The glass composition of claim 1, further comprising:
Al₂O₃ not more than 8 wt %.

4. The glass composition of claim 3, further comprising:
at least one member selected from the group consisting of MgO, CaO, SrO, and BaO, not more than 20 wt % in total.

5. The glass composition of claim 1, wherein
SiO₂ content is not more than 0.5 wt %.

6. A glass composition, comprising:
GeO₂ 0.1-20 wt %;
B₂O₃ 3-20 wt %;
ZnO 4-30 wt %; and
Bi₂O₃ 40-80 wt %.

7. The glass composition of claim 6, further comprising:
at least one member selected from the group consisting of MgO, CaO, SrO, and BaO, not more than 20 wt % in total.

8. The glass composition of claim 6, further comprising:
Al₂O₃ not more than 8 wt %.

9. The glass composition of claim 8, further comprising:
at least one member selected from the group consisting of MgO, CaO, SrO, and BaO, not more than 20 wt % in total.

10. The glass composition of claim 6, wherein
SiO₂ content is not more than 0.5 wt %.

11. A glass composition comprising:
GeO₂ 0.1-20 wt %;
B₂O₃ 12-35 wt %;
ZnO 15-45 wt %; and
Bi₂O₃ 10-40 wt %.

12. The glass composition of claim 11, further comprising:
at least one member selected from the group consisting of MgO, CaO, SrO, and BaO, not more than 20 wt % in total.

13. The glass composition of claim 11, further comprising:
Al₂O₃ not more than 8 wt %.

14. The glass composition of claim 13, further comprising:
at least one member selected from the group consisting of MgO, CaO, SrO, and BaO, not more than 20 wt % in total.

15. The glass composition of claim 11, wherein
SiO₂ content is not more than 0.5 wt %.

16. A paste composition comprising:
the glass composition of claim 1, binder resin, and solvent.

17. A plasma display panel comprising:
an electrode provided on a surface that faces into a discharge space; and
a dielectric layer provided so as to cover the electrode,
wherein the dielectric layer is composed of the glass composition of claim 1.

18. A plasma display panel comprising:
an electrode provided on a surface that faces into a discharge space;
a first dielectric layer provided so as to cover the electrode; and
a second dielectric layer provided so as to cover the first dielectric layer,
wherein, of the first dielectric layer and the second dielectric layer, at least the first dielectric layer is composed of the glass composition of claim 1.

19. The plasma display panel of claim 18,
wherein the second dielectric layer is composed of a SiO₂—B₂O₃—ZnO glass composition.

20. The plasma display panel of claim 18, wherein
the glass composition that composes the first dielectric layer has a higher softening point that the glass composition that composes the second dielectric layer.
